(19) United States
(12) Patent Application Publication
(10) Pub. No.: US 2009/0138910 A1
(43) Pub. Date: May 28, 2009

(54) METHOD AND APPARATUS FOR SETTING AND ENABLING SHORTCUT KEY OF REMOTE CONTROLLER

(75) Inventors: Ho JIN, Yongin-si (KR); Young-chul SOHN, Seoul (KR); Yong-jun KIM, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/323,988

(22) Filed: Nov. 26, 2008

Related U.S. Application Data
(60) Provisional application No. 60/990,392, filed on Nov. 27, 2007.

(30) Foreign Application Priority Data
Nov. 19, 2008 (KR) 10-2008-0115331

(51) Int. Cl. G06F 13/00; H04L 17/02; G06F 3/02

(52) U.S. Cl. 725/38; 341/176; 345/169

(57) ABSTRACT

Provided are a method and apparatus for setting/enabling a shortcut key of a remote controller. The method includes executing an application including device control software, requesting selection of a key of the remote controller that is to be mapped to the device control software when the device control software is selected, downloading the device control software when the key of the remote controller is selected, and mapping the device control software to the key of the remote controller.

### CROSS-REFERENCE TO RELATED PATENT APPLICATION

This application claims the benefit of U.S. Provisional Application No. 60/990,392, filed on Nov. 27, 2007, and Korean Patent Application No. 10-2008-0115331, filed on Nov. 19, 2008, the disclosures of which are incorporated herein in their entirety by reference.

### BACKGROUND OF THE INVENTION

1. Field of the Invention

Methods and apparatuses consistent with the present invention relate to setting and enabling a shortcut key of a remote controller, and more particularly, to setting and enabling a shortcut key of a remote controller so that an application may be executed in an image device, such as a digital television (DTV), a set-top box (STB), or a personal computer (PC), by manipulating the shortcut key of the remote controller only once.

2. Description of the Related Art

Various functions of an image device, such as a DTV, an STB or a PC), are performed by manipulating a button on a control panel or a button on a remote controller. However, a user often has to go through complicated processes to perform various functions.

Thus, there is a growing need to develop a method of setting a function of an image device, which a user frequently uses, as a shortcut key of a remote controller so that the user may conveniently use the function.

### SUMMARY OF THE INVENTION

The present invention provides a method and apparatus for setting and enabling a shortcut key of a remote controller so that an application may be executed by manipulating the shortcut key on the remote controller only once.

According to an aspect of the present invention, there is provided a method of setting a shortcut key of a remote controller, the method including executing an application including device control software, in an image device; if the device control software is selected, requesting selection of a key of the remote controller that is to be mapped to the device control software; if the key of the remote controller is selected, downloading the device control software; and mapping the device control software to the selected key of the remote controller.

According to another aspect of the present invention, there is provided a method of enabling a shortcut key of a remote controller, the method including receiving a signal of a key of the remote controller, where the signal indicates a manner in which the key is manipulated; determining whether the key is a shortcut function key based on the received signal; detecting device control software mapped to the key if it is determined that the key is a shortcut function key; and loading and executing the detected device control software.

According to another aspect of the present invention, there is provided an image device including a remote controller receiving unit receiving a signal of a key from a remote controller; a modem unit transmitting and receiving web page data of a web site that a user wants to access via web browsing; a signal processing unit transforming the web page data into a video signal; a display unit displaying the video signal received from the signal processing unit; and a control unit connected to the Internet via the modem unit, mapping the signal of the key, received from the remote controller receiving unit, to device control software linked to the web site, and executing the device control software mapped to the key when a preset shortcut function key is manipulated.

### BRIEF DESCRIPTION OF THE DRAWINGS

The above and other aspects of the present invention will become more apparent from the following detailed description of exemplary embodiments, with reference to the attached drawings in which:

FIG. 1 is a block diagram of a system for processing an input signal of a shortcut key on a remote controller according to an exemplary embodiment of the present invention;

FIG. 2 is a block diagram illustrating in detail an image device of FIG. 1 according to an exemplary embodiment of the present invention;

FIG. 3 is a flowchart illustrating a method of setting a shortcut key of a remote controller according to an exemplary embodiment of the present invention;

FIGS. 4A and 4B are diagrams illustrating the method of FIG. 3 being performed according to an exemplary embodiment of the present invention;

FIG. 5 is a diagram illustrating a method of processing an input signal of a shortcut key on a remote controller according to an exemplary embodiment of the present invention;

FIG. 6 is a block diagram illustrating a method of extending a function of setting a shortcut key of a remote controller according to an exemplary embodiment of the present invention;

FIG. 7 is a flowchart illustrating a method of enabling a shortcut key on a remote controller according to an exemplary embodiment of the present invention;

FIG. 8 is a flowchart illustrating a method of setting a shortcut key of a remote controller according to another exemplary embodiment of the present invention;

FIGS. 9A and 9B are diagrams illustrating the method of FIG. 8 being performed according to an exemplary embodiment of the present invention;

FIG. 10 is a flowchart illustrating a method of enabling a shortcut key on a remote controller according to another exemplary embodiment of the present invention; and

FIG. 11 is a diagram illustrating the method of FIG. 10 being performed according to an exemplary embodiment of the present invention.

### DETAILED DESCRIPTION OF EXEMPLARY EMBODIMENTS OF THE INVENTION

Hereinafter, exemplary embodiments of the present invention will be described in greater detail with reference to the accompanying drawings.

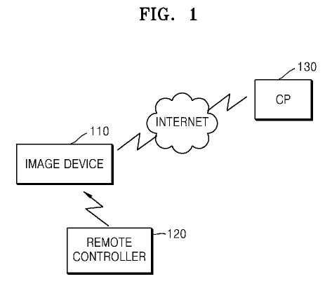

FIG. 1 is a block diagram of a system for processing an input signal of a shortcut key on a remote controller according to an exemplary embodiment of the present invention. Referring to FIG. 1, the system includes an image device 110, a remote controller 120, and a content provider 130.

The image device 110 is connected to the Internet to select software from among a plurality of device control software codes/programs provided in a web site on the Internet, requests selection of a key on a remote controller 120 that is to be mapped to the selected software, downloads the selected software when the selected key on the remote controller 120 is manipulated, and then maps the selected software to the selected key on the remote controller 120. The image device 110 also maps a key on the remote controller 120 to an application, and executes the application when an input signal of the mapped key on the remote controller 120 is received. The image device 110 also transmits information regarding the application in the form of a radio-frequency (RF) signal to the remote controller 120.

By a user's manipulation, the remote controller 120 transmits to the image device 110, information regarding the key that is to be mapped to the application or the selected software, and a key signal for executing the application or the selected software. The remote controller 120 also displays in a predetermined display window thereof information regarding the application or simple web information which is received in the form of an RF signal from the image device 110. In this case, the key may be at least one of menu keys, number keys, and directional keys.

The content provider 130 provides web page data or the plurality of device control software codes/programs.

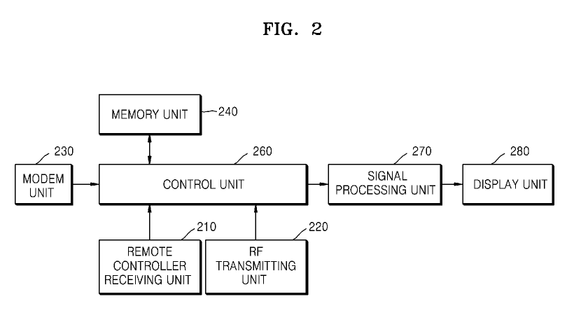

FIG. 2 is a block diagram illustrating in detail the image device 110 of FIG. 1 according to an exemplary embodiment of the present invention. Referring to FIG. 2, the image device 110 includes a remote controller receiving unit 210, an RF transmitting unit 220, a modem unit 230, a memory unit 240, a control unit 260, a signal processing unit 270, and a display unit 280.

The remote controller receiving unit 210 receives a key signal from the remote controller 120 of FIG. 1.

The RF transmitting unit 220 transforms an application selected by the control unit 260 or information thereof into an RF signal, and transmits the RF signal to the remote controller 120.

The modem unit 230 is connected to the Internet, and receives or transmits web page data of a web site that a user desires to access via web browsing.

The memory unit 240 includes read-only memory (ROM) and random access memory (RAM), and stores a control program for driving the control unit 260 and a mapping table formed when mapping specific keys and device control software.

The signal processing unit 270 transforms web page data and content data received from the control unit 260 into an RGB signal, and combines an on-screen display (OSD) signal with the RGB signal.

The display unit 280 includes a liquid crystal display (LCD) or a cathode ray tube (CRT), or other display as would be understood by one of skill in the art, and displays a video signal and menu information, which are received from the signal processing unit 270, in the form of a pop-up window or another type of graphic representation.

The control unit 260 is connected to the Internet via the modem unit 230 to read web page data, constructs a shortcut key mapping table by mapping an application or device control software selected by the remote controller 120 to a key on the remote controller 120, and drives the application or the device control software mapped to the key when the shortcut key on the remote controller 120 is manipulated. Also, the control unit 260 transmits device control software selected and driven by a user and information thereof to the remote controller 120 via the RF transmitting unit 220.

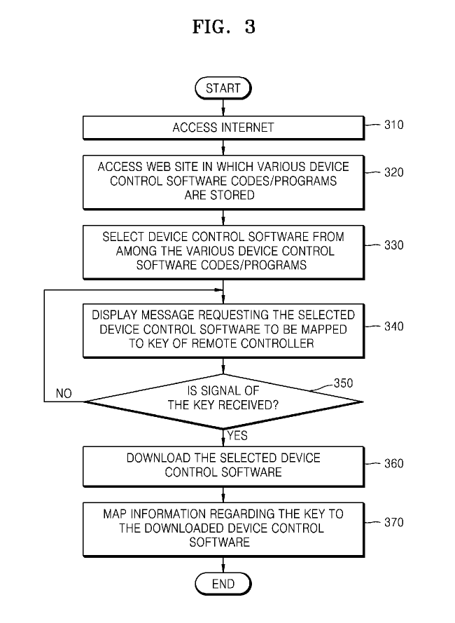

FIG. 3 is a flowchart illustrating a method of setting a shortcut key of a remote controller according to an exemplary embodiment of the present invention. First, a web browser corresponding to an application is run in order to access the Internet (operation 310).

Next, a web site in which various device control software codes/programs are stored is accessed (operation 320).

In an exemplary embodiment of the present invention, the various device control software codes/programs include a plug-in module for controlling devices in a home network, and script files consisting of visual basic and Java for controlling and executing execution modules such as Active X. Here, each of the script files includes a plurality of scripts consisting of data, a definition, and an imperative. Each script file is decrypted and executed in units of imperative sentences. Also, the various device control software codes/programs are provided from a server.

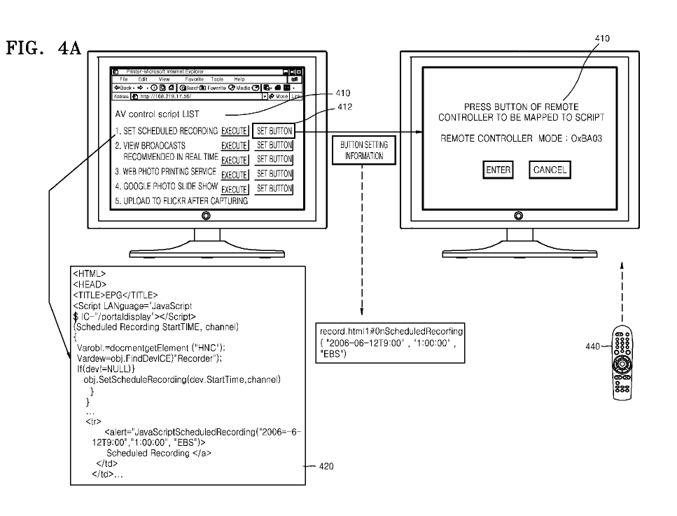

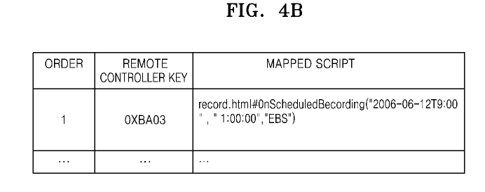

For example, as illustrated in FIG. 4A, when a web site storing a plurality of audio/video (AV) control script files is accessed, the AV control script files are displayed on an image device screen 410. For example, the AV control script files include “1. Set scheduled recording, 2. View broadcasts recommended in real time”, and so on. In an exemplary embodiment of the present invention, a script 420 regarding “1. Set scheduled recording” includes a simple sentence regarding a process of setting scheduled recording.

Then, device control software is selected from among the various device control software codes/programs by manipulating a selection key on a remote controller 440 (operation 330). For example, as illustrated in FIG. 4A, a button setting command button 412 regarding the script 420 “1. Set scheduled recording”, is selected in the image device screen 410. In this case, button setting information is defined as “record.html#OnScheduledRecording (“2006-06-12T9:00”’,“1:00:00’ “EBS”)”.

Next, if a user selects the device control software, a message requesting that the device control software be mapped to a key of the remote controller is displayed on the image device screen 410 (operation 340). That is, an image device allows a user to request that a desired key of the remote controller be selected by manipulating the desired key, and displays a message confirming the manipulated key.

For example, as illustrated in FIG. 4A, when the button setting command button 412 is selected in the image device screen 410, a message, “Press a button on a remote controller to be mapped to the script” is displayed on the image device screen 410.

Next, it is checked whether a signal of the key for mapping is received from the remote controller (operation 350). In this case, a message confirming the key of the remote controller mapped to the device control software indicated by the message regarding the mapping is displayed on the image device screen 410.

For example, as illustrated in FIG. 4A, when a key signal is received from a remote controller 440, key code, “OxBA03” of the remote controller 440 and “Enter” and “Cancel” command buttons are displayed on the image device screen 410.

Next, when a key of the remote controller 440 is manipulated, the selected device control software is downloaded (operation 360).

For example, as illustrated in FIG. 4A, if a user manipulates the “Enter” command button displayed on the image device screen 410 via the remote controller 440, a script regarding “Set up scheduled recording” is downloaded.

Next, information regarding the key of the remote controller 440 is mapped to the downloaded device control software (operation 370).

Next, a mapping table for mapping the device control software and the key of the remote controller 440 is created.

For example, as illustrated in FIG. 4B, a mapping table between a code of a key numbered ‘1’ of the remote controller and a specific script is created. That is, the code, “OxBA03” of the key numbered ‘1’ of the remote controller 440 is mapped to a script, “record.html#OnScheduledRecording(“2006-06-12T9:00”, “1:00:00”, “EBS”)”.

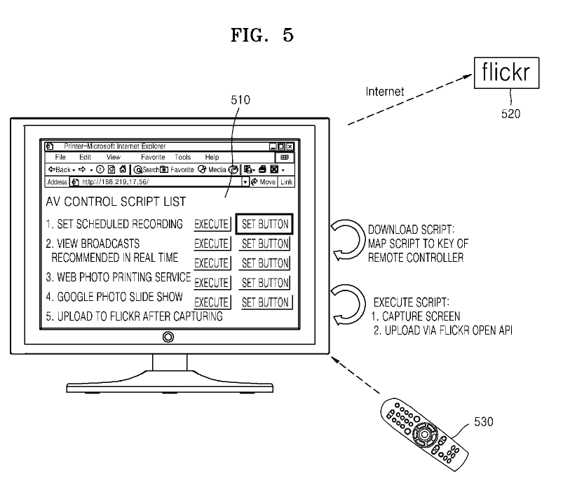

FIG. 5 is a diagram illustrating a method of processing an input signal of a shortcut key on a remote controller according to an exemplary embodiment of the present invention. Referring to FIG. 5, in a shortcut key setting mode, an image device downloads a script displayed on a screen 510 of the image device and maps the downloaded script to a specific key of a remote controller 530. Then, if receiving an input signal of the specific key of the remote controller 530 in a shortcut key enabling mode, the image device executes the downloaded script. For example, when a specific key designating a script corresponding to “Upload to Flickr after capturing” is received from the remote controller 530, the image device captures a current screen, and performs downloading to a content provider via a program interface, e.g., Flickr Open Application Programming Interface (API).

Accordingly, according to an exemplary embodiment of the present invention, various control functions of devices in a home network may be performed by simply manipulating a button on a remote controller only once.

That is, according to an exemplary embodiment of the present invention, a script is assigned to a shortcut key of a remote controller, and thus it is possible to control power supplied to devices in a home network, change functions of the remote controller, or perform a batch job by simply manipulating a button on the remote controller only once.

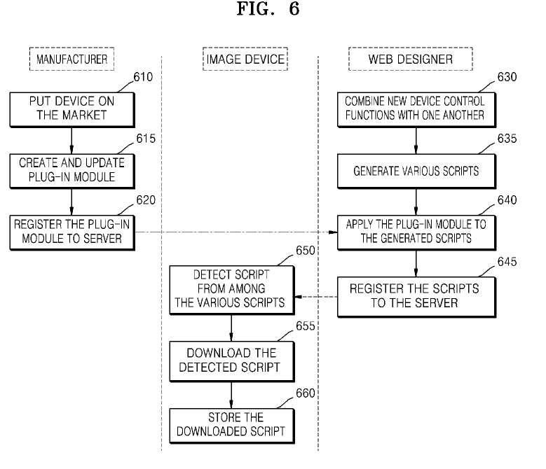

FIG. 6 is a block diagram illustrating a method of extending a function of setting a shortcut key of a remote controller according to an exemplary embodiment of the present invention. A manufacturer places an image device on the market (operation 610), and newly creates or updates a plug-in module (operation 615). Next, the manufacturer registers the plug-in module to a server (operation 620) and provides the plug-in module to a web designer.

The web designer combines new device control functions with one another (operation 630) and generates various scripts for controlling devices in a network from the combination of the new device control functions (operation 635). Then the web designer applies the plug-in module received from the manufacturer to the generated scripts (operation 640), and then registers the scripts to the server (operation 645).

The image device detects a script from among the various scripts received from the web designer according to a user's selection made via the remote controller (operation 650), downloads the detected script (operation 655), and then stores the downloaded script (operation 660).

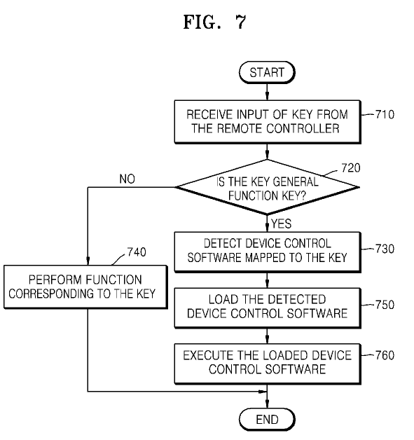

FIG. 7 is a flowchart illustrating a method of enabling a shortcut key on a remote controller according to an exemplary embodiment of the present invention. First, an input signal of a specific key is received from the remote controller (operation 710)

Next, it is determined whether the specific key is a general function key or a shortcut function key by checking a manner in which the input specific key is manipulated (operation 720). For example, if a key numbered ‘1’ is manipulated for a predetermined time or longer, the key is considered as a shortcut function key, and if the key numbered ‘1’ is manipulated for less than the predetermined time, the key is considered as a general function key. In another exemplary embodiment of the present invention, whether the specific key is a shortcut function key may be determined based on a combination of predetermined keys being manipulated.

Next, if it is determined that the specific key is a shortcut function key, device control software, e.g., a script file for scheduled recording, which is mapped to the specific key is detected using a predetermined mapping table (operation 730).

If it is determined that the specific key is a general function key, a general function corresponding to the specific key is performed (operation 740)

Next, the detected device control software is loaded (operation 750).

Next, the loaded device control software is executed (operation 760).

For example, if a key numbered ‘1’ is mapped to a script for ‘scheduled recording’, a script file describing a process of setting scheduled recording is executed.

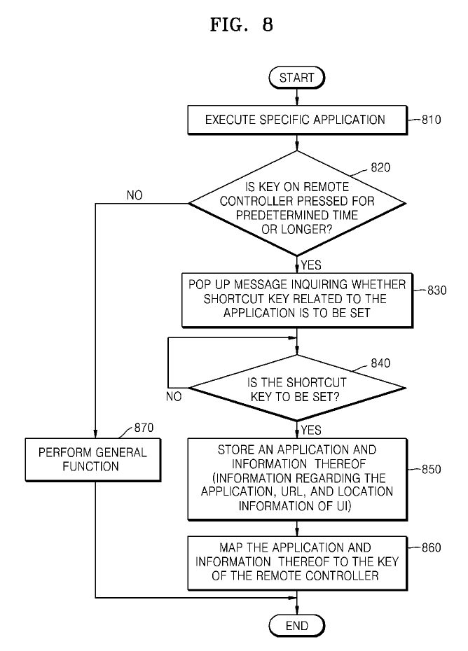

FIG. 8 is a flowchart illustrating a method of setting a shortcut key of a remote controller according to another exemplary embodiment of the present invention. First, a specific application, such as a web browser or a widget, is executed (operation 810).

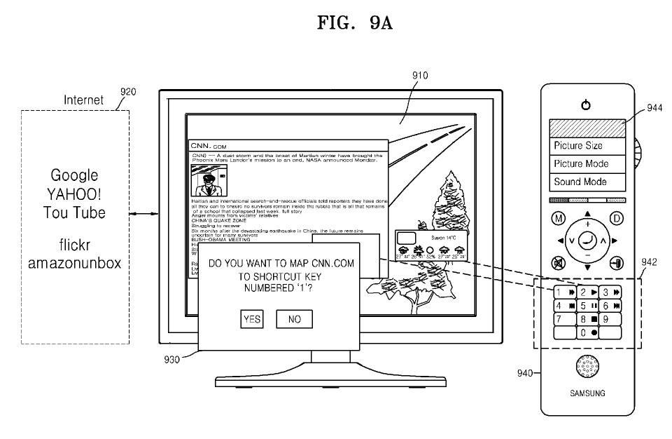

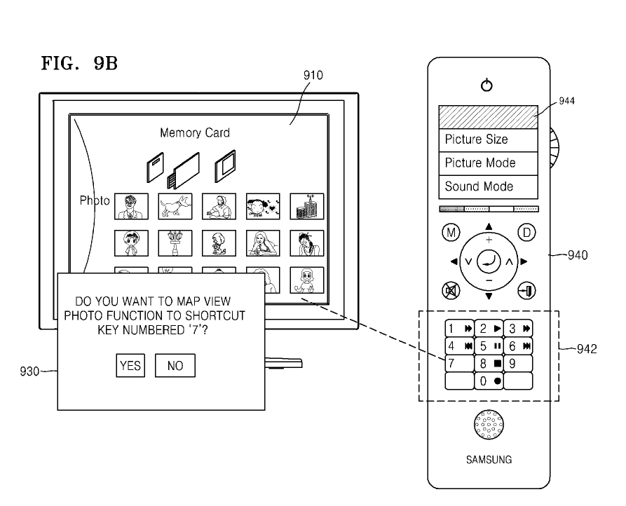

For example, as illustrated in FIGS. 9A and 9B, a web page or a widget provided from a content provider 920, or software for viewing photos stored in a memory card, is executed.

Next, it is determined whether a specific key on the remote controller is manipulated for a predetermined time or longer (operation 820).

Next, if it is determined that the specific key is manipulated for the predetermined time or longer, a message inquiring whether a shortcut key related to the application is to be set appears in a popup window (operation 830). For example, as illustrated in FIG. 9A, if a key numbered ‘1’ of an input unit 942 on the remote controller 940 is manipulated for three or more seconds, a shortcut key setting message 930, “Do you want to map CNN.com to a shortcut key numbered ‘1’?” is displayed on a TV screen 910.

For example, as illustrated in FIG. 9B, if a key numbered ‘7’ of the input unit 942 on the remote controller 940 is manipulated for three or more seconds, a shortcut key setting message 930, “Do you want to map a ‘View photo’ function to a shortcut key numbered ‘7’?” is displayed on a TV screen 910.

However, if it is determined that the specific key is not manipulated for the predetermined time or longer, a general function mapped to the specific key is performed (operation 870).

Next, it is determined whether the shortcut key is to be set (operation 840).

If it is determined that the shortcut key is to be set, an assigned application and information related thereto is stored (operation 850). In this case, the information related to the assigned application includes information regarding an execution application (a browser, a widget, or an application for viewing photos stored in a memory card), a uniform resource locator (URL), and location information (X and Y coordinates, width, and height) of a user interface (UI), as illustrated in FIGS. 9A and 9B.

Next, the application and information thereof and the specific key on the remote controller are mapped to each other (operation 860).

For example, as illustrated in FIG. 9A, a web browser and information related thereto and information related to the widget on the image device screen 910 are mapped to the key numbered ‘1’ on the remote controller 940. Also, a widget and information related thereto on the image device screen 910 are mapped to the key numbered ‘2’ on the remote controller 940.

Accordingly, according to the above exemplary embodiments, an application may be executed by manipulating a specific key on a remote controller only once, and thus, it is possible to solve a problem of a related art remote controller, in that a multi-step process is required to execute an application.

Also, according to the above exemplary embodiments, it is possible to map not only an application but also UI location information of various applications, e.g., a browser or a widget, to a shortcut key.

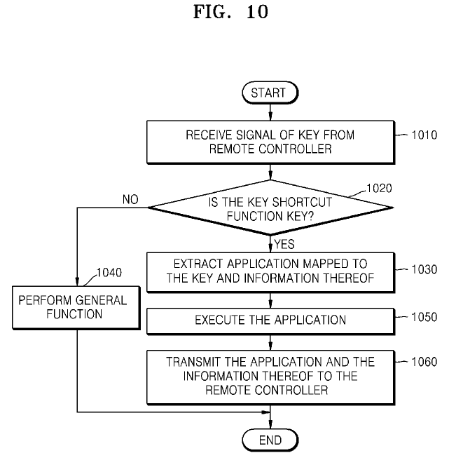

FIG. 10 is a flowchart illustrating a method of enabling a shortcut key on a remote controller according to another exemplary embodiment of the present invention. First, a signal of a key on the remote controller is received from the remote controller (operation 1010).

Next, whether the key is a shortcut function key is determined by checking a manner in which the specific key is manipulated (operation 1020).

If it is determined that the key is not a shortcut function key, a general function mapped to the specific key is performed (operation 1040).

Next, an application and information related to the application that are mapped to the key are extracted according to the manner in which the key is manipulated (operation 1030). In this case, the information related to the application includes information regarding an application executed according to an exemplary embodiment of the present invention, a URL, and UI location information.

Next, the extracted application and information are executed (operation 1050). That is, the application is executed based on the URL and UI location information mapped to the key.

Thereafter, the executed application and the information thereof are transmitted to the remote controller according to a user's selection (operation 1060).

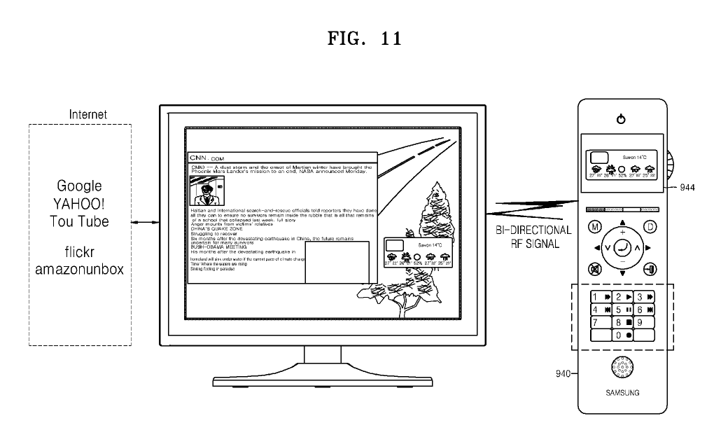

For example, as illustrated in FIG. 11, the remote controller 940 receives simple web information in the form of a bi-directional RF signal from an image device and then displays the received information on a display window 944.

Therefore, an application and information thereof received from the image device are displayed on the display window 944, and thus, a user may read the simple web information via the remote controller 940 without having to turn on the image device.

The present invention may be embodied as computer readable code in a computer readable recording medium. Here, the computer readable recording medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. The computer readable recording medium may be distributed among computer systems that are interconnected through a network, and the present invention may be stored and implemented as computer readable code in the distributed system.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of setting a shortcut key of a remote controller, the method comprising:
executing, in an image device, an application including device control software;
if the device control software is selected, requesting selection of a key of the remote controller that is to be mapped to the device control software;
if the key of the remote controller is selected, downloading the device control software; and
mapping the device control software to the selected key of the remote controller.

2. The method of claim 1, wherein the requesting selection of the key of the remote controller comprises displaying a message requesting that the device control software be mapped to the key of the remote controller on a screen of the image device.

3. The method of claim 1, wherein the requesting selection of the key of the remote controller comprises receiving a request that a desired key of the remote controller be selected, via manipulation of the desired key, and displaying a message confirming the manipulated key.

4. The method of claim 1, wherein the mapping the device control software to the key comprises creating a mapping table by mapping the device control software to the selected key of the remote controller.

5. The method of claim 1, wherein the device control software comprises a script file for performing device control.

6. The method of claim 5, wherein the script file comprises sentences for controlling devices in a home network.

7. The method of claim 1, wherein the script file comprises a plurality of imperative sentences,
wherein each of the imperative sentences comprises data, a definition, and an imperative, and
the script file is decrypted and executed in units of the imperative sentences.

8. A method of enabling a shortcut key of a remote controller, the method comprising:
receiving a signal of a key of the remote controller, wherein the signal indicates a manner in which the key is manipulated;
determining whether the key is a shortcut function key based on the received signal;
if it is determined that the key is a shortcut function key, detecting device control software mapped to the key; and
loading and executing the detected device control software.

9. The method of claim 8, wherein the determining whether the key is a shortcut function key comprises determining that the key is a shortcut function key if the received signal indicates that the key is manipulated for at least a predetermined amount of time.

10. A method of setting a shortcut function key of a remote controller, the method comprising:
executing an application in an image device;
determining a manner in which a key of the remote controller is manipulated;
storing the application and information related to the application, based on the manner in which the key is manipulated; and
mapping the stored application and information to the key of the remote controller.

11. The method of claim 10, wherein the information related to the application comprises information regarding an execution application, link information, and location information of a user interface.

12. The method of claim 10, further comprising displaying a shortcut key setting message if the key of the remote controller is manipulated for at least a predetermined amount of time.

13. A method of enabling a shortcut key of a remote controller, the method comprising:
determining a manner in which a key of the remote controller is manipulated; and
executing an application mapped to the key of the remote controller according to the manner in which the key is manipulated.

14. The method of claim 13, wherein the executing the mapped application comprises executing the application based on link information and location information of a user interface mapped to the key of the remote controller.

15. A method of processing an input signal of a shortcut key of a remote controller, the method comprising:
determining a manner in which a key of the remote controller is manipulated;
detecting an application and information related to the application mapped to the key of the remote controller according to the manner in which the key is manipulated; and
transmitting the detected application and information to the remote controller.

16. The method of claim 15, further comprising displaying the application and the information related to the application on a remote controller.

17. An image device comprising:
a remote controller receiving unit which receives a signal of a key from a remote controller;
a modem unit which transmits and receives web page data of a web site that a user wants to access via web browsing;
a signal processing unit which transforms the web page data into a video signal;
a display unit which displays the video signal received from the signal processing unit; and
a control unit connected to the Internet via the modem unit, which maps the signal of the key, received from the remote controller receiving unit, to device control software linked to the web site, and executes the device control software mapped to the key if a preset shortcut function key of the remote controller is manipulated.

18. The device of claim 17, further comprising a radio-frequency transmitting unit which transmits web information to the remote controller according to a selection of a user.

19. A computer readable recording medium having recorded thereon a computer program for executing the method of claim 1.

20. A computer readable medium having recorded thereon a computer program for executing the method of claim 8.

21. A method of setting a shortcut key for a remote controller, the method comprising:
displaying a message requesting device control software to be mapped to a key of the remote controller;
receiving a signal from the remote controller indicating that a selected key has been indicated;
mapping the device control software to information regarding the selected key; and
saving mapping information in a memory unit.

22. A method of processing an input signal of a key of a remote controller, the method comprising:
receiving a signal indicating that the key of the remote controller has been manipulated;
determining that the key is a shortcut function key if the received signal indicates that the input key was manipulated for at least a predetermined amount of time;
determining that the input key is a general function key if the received signal indicates that the input key was manipulated for less than the predetermined amount of time;
if it is determined that the input key is a shortcut function key, determining device control software which is mapped to the shortcut function key, and executing the device control software; and
if it is determined that the input key is a general function key, performing a function which corresponds to the general function key.

23. A method of setting a shortcut key for a remote controller, the method comprising:
executing an application;
receiving a signal indicating that the key of the remote controller has been manipulated for at least a predetermined amount of time;
displaying a message inquiring whether the input key is to be mapped to the executed application;
receiving a signal indicating that the input key is to be mapped to the executed application;
mapping the device control software to information regarding the selected key; and saving mapping information in a memory unit.
